(19) United States
(12) Patent Application Publication
(10) Pub. No.: US 2025/0256346 A1
(43) Pub. Date: Aug. 14, 2025

(54) TORCH CABLE SUPPORT WITH ANCILLARY POWER SOURCE

(71) Applicant: ESAB AB, Gothenburg (SE)

(72) Inventors: Marc Hartel, Reiskirchen (DE); Ulrich Kaldenbach, Gruenberg (DE); Mike Engel, Giessen (DE)

(21) Appl. No.: 19/076,084

(22) Filed: Mar. 11, 2025

Related U.S. Application Data
(63) Continuation of application No. PCT/IB2023/059156, filed on Sep. 14, 2023.
(60) Provisional application No. 63/407,338, filed on Sep. 16, 2022.

(51) Int. Cl. B23K 9/32; B23K 9/16

(52) U.S. Cl. CPC B23K 9/323; B23K 9/16

(57) ABSTRACT

A torch cable connector with an ancillary or auxiliary power source for powering ancillary torch components. In addition, a torch and connector system that has an independent power supply for additional functions, such as sensors or lighting on a welding torch. In one implementation, a manual welding torch may include one or more batteries or power sources that can be used to power additional functions independent from the welding machine. The auxiliary power source is separate from any power being supplied to the torch for its operation.

### CROSS-REFERENCE TO RELATED APPLICATIONS

This patent application is a continuation application of, and claims the benefit of and priority to International Application No. PCT/IB2023/059156, filed on Sep. 14, 2023, entitled “Torch Cable Connector Assembly, Torch Cable Assembly and Torch, With Ancillary Power Source”, with Attorney Docket No. 1485.1055i, which claims the benefit of and priority to U.S. Patent Application No. 63/407,338, filed on Sep. 16, 2022, entitled “Torch Cable Support With Ancillary Power Source,” with Attorney Docket No. 1485.1055P. The entire disclosure of each of the two above-identified patent applications is incorporated herein by reference in its entirety.

### TECHNICAL FIELD

The present disclosure is directed toward an arc process (e.g., cutting or welding) component and, in particular, to an arc process torch cable support or connector that has an ancillary power source for powering auxiliary or ancillary components of an arc process torch.

### BACKGROUND OF THE INVENTION

Power or voltage is provided to a torch by a power supply of a welding machine. This power supply applies to the welding current as well as to the power supply for additional or auxiliary functions. Arc process torches, such as welding and cutting torches, may include an auxiliary or ancillary component that is ancillary to the specific process of generating a weld or a stream of plasma. In different examples, an auxiliary component may be a controller for adjusting one or more parameters of a power supply, a light (e.g., LED) for illuminating a workpiece, a sensor for providing feedback to the power supply, or a remote control.

In a torch that includes an auxiliary or ancillary component, the auxiliary component may receive power from a power supply via a separate connector that is machine-specific (i.e., designed for a specific power supply). In addition, the voltage can also vary with different welding machines. However, if a power supply does not include an auxiliary power supply, or the torch and cable are not compatible with the power supply (i.e., not from the same manufacturer), auxiliary or ancillary torch components may not be powered due to a lack of power (i.e., the torch operates without full functionality).

In some instances, since both the plug types and voltage are different, even with the same manufacturer, a separate connection plug and even a separate circuit board for regulating the voltage must be provided for each version. As a result, in some instances, the cable, and thus the torch, can only be connected to certain power supplies from certain manufacturers for an auxiliary or ancillary torch component to operate.

### SUMMARY OF THE INVENTION

The techniques described herein relate to a torch cable connector with an ancillary or auxiliary power source for powering ancillary torch components. In addition, the techniques described herein relate to a torch and connector system that has an independent power source for additional functions, such as sensors or lighting on a welding torch. In one implementation, a manual welding torch may include one or more batteries or power sources that can be used to power additional functions independent from the welding machine. The auxiliary power source is separate from any power being supplied to the torch for its operation.

In one implementation, the techniques described herein relate to a torch cable connector assembly for use with a torch having an auxiliary component, the torch cable connector assembly comprises a torch cable having a first end and a second end opposite to the first end, the first end being configured to be coupled to the torch, and a connector coupled to the second end of the torch cable, the connector including an auxiliary power source, the auxiliary power source being connectable to the auxiliary component in the torch to provide power thereto, the auxiliary power source being separate from any power being supplied to the torch for its operation.

In one embodiment, the connector has a first connector end and a second connector end opposite to the first connector end, the first connector end being coupled to the second end of the torch cable, and the connector has a power pin extending from the second connector end. In another embodiment, power passing through the power pin does not power the auxiliary component.

In another embodiment, the connector has a body that defines a cavity in which the auxiliary power source is placed. In an alternative embodiment, the cavity is a battery compartment, and the auxiliary power source is a plurality of batteries located in the cavity. In yet another embodiment, the connector includes an information port for receiving a machine connection plug.

In one embodiment, a torch cable assembly comprises a torch having an auxiliary component, a torch cable having a first end and an opposite second end, the first end of the torch cable being coupled to the torch, the torch receiving power from a power supply via the torch cable, and a cable support being coupled to the second end of the torch cable, the cable support including a power pin through which at least one of power or fluid passes, and an auxiliary power source that is connected to the auxiliary component in the torch to provide power to the auxiliary component.

In an alternative embodiment, the auxiliary component is one of an LED, a controller, a sensor, or a human-to-machine interface. In another embodiment, the auxiliary component is a first auxiliary component, and the torch cable assembly further comprises a second auxiliary component located in the torch, the second auxiliary component being a different type of component than the first auxiliary component. In yet another embodiment, each of the first auxiliary component and the second auxiliary component is powered by the auxiliary power source located in the cable support. In another embodiment, the auxiliary power source includes at least one battery located in the cable support. In yet another embodiment, the at least one battery is located in a cavity formed in the cable support, and the at least one battery is removable from the cavity. Alternatively, the cable support includes an on/off switch for connecting and disconnecting the auxiliary power source from the auxiliary component. Also, the cable support includes an information port for receiving a machine connection plug.

In one embodiment, a torch comprises a handle, an auxiliary component coupled to the handle, a torch cable coupled to the handle, and a cable support coupled to the torch cable, the cable support including an auxiliary power source, the auxiliary power source being connected to the auxiliary component in the handle, wherein the torch cable provides power from a power supply for operation of the torch, and the torch cable provides power from the auxiliary power source to the auxiliary component for operation of the auxiliary component.

In one embodiment, the cable support is coupleable to a power supply to receive at least one of power or fluid for the torch. In another embodiment, the cable support includes a power pin extending therefrom which can receive the at least one of power or fluid for the torch. In yet another embodiment, the auxiliary power source includes at least one battery located in a battery compartment formed in the cable support.

In an alternative embodiment, the auxiliary component is one of an LED, a controller, a sensor, or a human-to-machine interface, and the handle includes a trigger coupled thereto, the trigger being manipulated by a user to start or stop a welding process. In yet another embodiment, the cable support includes an information port for receiving a machine connection plug.

### BRIEF DESCRIPTION OF THE DRAWINGS

The apparatuses, systems, devices, and components presented herein may be better understood with reference to the following drawings and description. It should be understood that some elements in the figures may not be to scale and that emphasis has been placed upon illustrating the principles disclosed herein. In the figures, like-referenced numerals designate corresponding parts/steps throughout the different views.

FIG. 1 illustrates a schematic block diagram of a torch and connector system according to an example embodiment.

FIG. 2 illustrates a side view of another embodiment of a torch and connector system.

FIG. 3 illustrates a perspective view of a portion of another embodiment of a torch and connector system.

FIG. 4 illustrates another perspective view of a portion of the torch and connector system illustrated in FIG. 3.

FIG. 5 illustrates another perspective view of a portion of the torch and connector system illustrated in FIG. 3 with the cable support being transparent.

FIG. 6 illustrates another perspective view of a portion of the torch and connector system illustrated in FIG. 3.

FIG. 7 illustrates another perspective view of a portion of the torch and connector system illustrated in FIG. 3.

### DETAILED DESCRIPTION

Generally, the techniques presented herein provide power to one or more auxiliary or ancillary torch components via an auxiliary or ancillary power source (e.g., one or more batteries) disposed either in or on a connector or cable support that is included in or coupled to a welding or cutting cable. In some implementations, this connector is disposed at the back end of the torch cable, which is the end of the torch cable that couples to the power supply. Accordingly, a torch with one or more auxiliary or ancillary components (e.g., an LED, a controller, a sensor, human-to-machine interface (“HMI”), etc.) may be connected to any power supply, regardless of the manufacturer of the power supply, and the auxiliary components may be powered independently from the power supply.

For example, if a power supply is incompatible with certain auxiliary or ancillary torch components, the auxiliary or ancillary power source may power the auxiliary or ancillary torch components while the power supply provides a weld or cut current and fluid flows (e.g., shield/process gas, water, etc.) via a power pin arrangement. Alternatively, if the power supply is compatible with the auxiliary or ancillary components, the battery may allow the power source's auxiliary power to be used for other features or purposes. Accordingly, the cable and torch may be coupled to any power supply, and all auxiliary or ancillary torch components may be fully operational. That is, the cable and torch are not machine-specific, and may be connected to a power supply from any manufacturer while the auxiliary or ancillary power source powers the auxiliary or ancillary torch components.

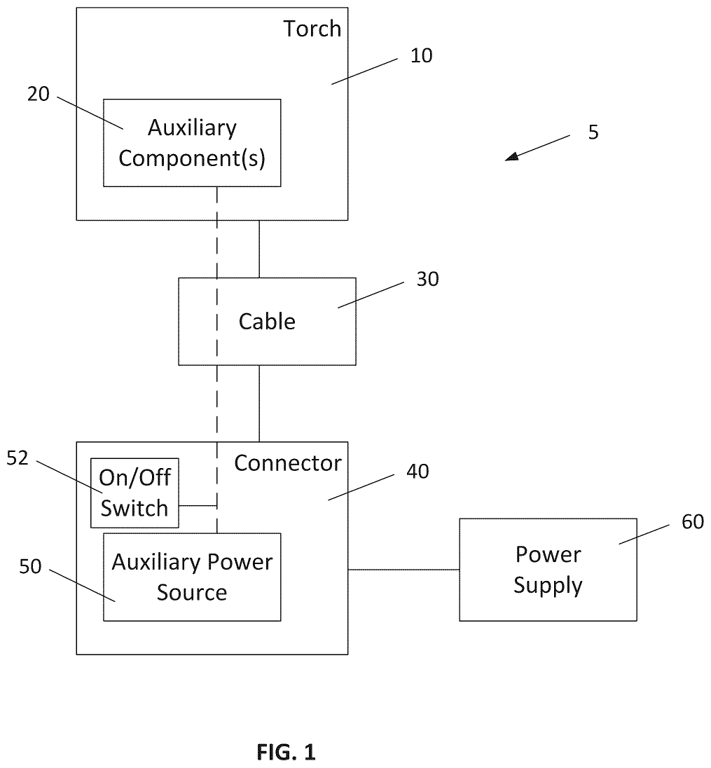

Referring to FIG. 1, a schematic diagram of an embodiment of a torch and connector system is illustrated. In this embodiment, torch and connector system 5 includes a torch 10, a cable 30 that is coupled to the torch 10, a connector 40 coupled to the cable 30, and a power supply 60 to which the connector 40 may be coupled. The power supply 60 provides power to the torch 10. The cable 30 and the connector 40 can be referred to alternatively as a torch cable connector assembly.

The torch 10 includes one or more auxiliary components 20, such as an LED, a controller, a sensor, or an HMI. The connector 40 includes an auxiliary power source or supply 50, which may be one or more batteries that are located in a battery component of the connector or cable support 40. The auxiliary power source 50 is connected to the auxiliary components 20 and provides power thereto. The battery compartment is located in the cable support 40, and enables a machine type-independent power supply for the auxiliary components 20 that provide additional features for the torch 10, such as an LED and sensors. In one embodiment, either the battery compartment for the auxiliary power source 50 or the connector or cable support may include an on/off switch 52 for connecting and disconnecting the auxiliary power source 50 with the auxiliary torch components. This results in the auxiliary power source 50 lasting longer.

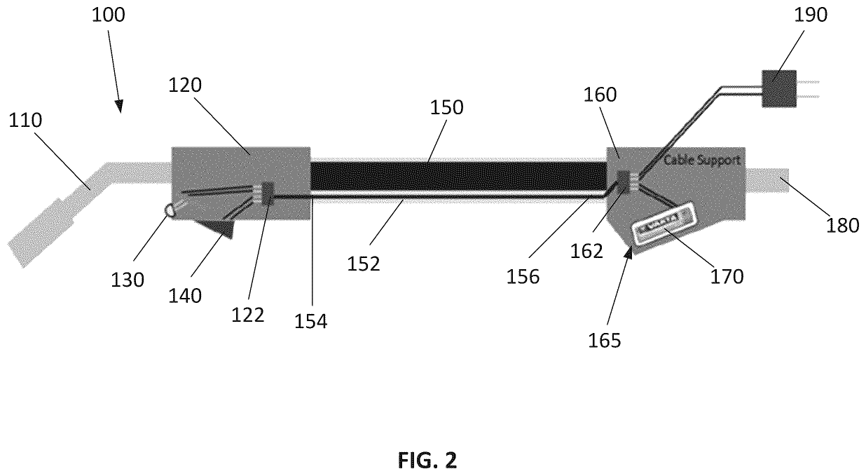

Referring to FIG. 2, a perspective view of an example embodiment of a torch and connector system is illustrated. In this embodiment, the torch and connector system includes a torch 100 with a conductor tube or torch neck 110, a handle 120, and a torch cable or cable hose 150. The torch cable 150 includes a cable support or connector 160 and a power pin 180 for engaging a power supply (not shown). The cable support 160 includes a battery or power source compartment 165 that is configured to receive an auxiliary power source 170, such as one or more batteries. Conductor or conductors 152 have a first end 156 that is coupled to electrical connector 162 and an opposite second end 154 that is coupled to electrical connector 122 and thus, to the torch components 130 (such as an LED) in the torch handle 120. Thus, the one or more batteries can power one or more torch components, which are referred to alternatively herein as ancillary or auxiliary components.

In FIG. 2, the one or more torch components comprise a light in the form of an LED 130. The battery or batteries 170 may also be operably connected to a trigger 140 in the torch 100 so that operation of the auxiliary component 130 (in this case LED 130) may be tied to operation of the trigger 140. The trigger is manipulated by a user to start and stop the welding process using the torch 100. In this embodiment, the handle 120 includes an electrical connector 122 which is coupled to wires connected to the LED 130 and to the trigger 140.

Additionally or alternatively, the auxiliary power source 170 may provide power to the light while control signals (e.g., trigger signals) are transmitted between the power supply and the one or more auxiliary or ancillary torch components 130 (e.g., the light) via a wire or connector in the cable or cable hose 150. As mentioned above, the auxiliary torch components are not intended to be limiting, and, in some instances, the auxiliary torch components may include one or more of any of sensors, controllers, HMIs and/or other ancillary components. Regardless of the specific type or quantity of ancillary components, in some implementations, the auxiliary or ancillary torch components may operate independently of the torch power supply. That is, ancillary components may be entirely powered by an auxiliary or ancillary power source (e.g., one or more batteries) included in the connector or cable support 160.

In some implementations, the battery or auxiliary power source 170 may power additional auxiliary or ancillary torch components, and signals from the additional auxiliary or ancillary torch components may be transmitted to the power supply. That is, the signals may be transmitted from the torch 100, through the cable 150 and the machine-specific connection plug 190, to the power supply. Thus, the additional auxiliary or ancillary torch components may control and/or communicate with the power supply without necessarily receiving power from the power supply.

In some implementations, the machine-specific connection plug 190 may be removably coupled to the cable support 160 such that the machine-specific connection plug 190 may be interchangeable with different types of connection plugs for different machines. Additionally or alternatively, a battery compartment 165 or cable support 160 may include an on/off switch for connecting and disconnecting the one or more batteries 170 to the torch components. In FIG. 2, the position of the cable support or connector 160 is merely an example and, in other embodiments, the cable support 160 (with one or more batteries 170) may be positioned adjacent to the torch 100 or the conductor tube/torch neck 110.

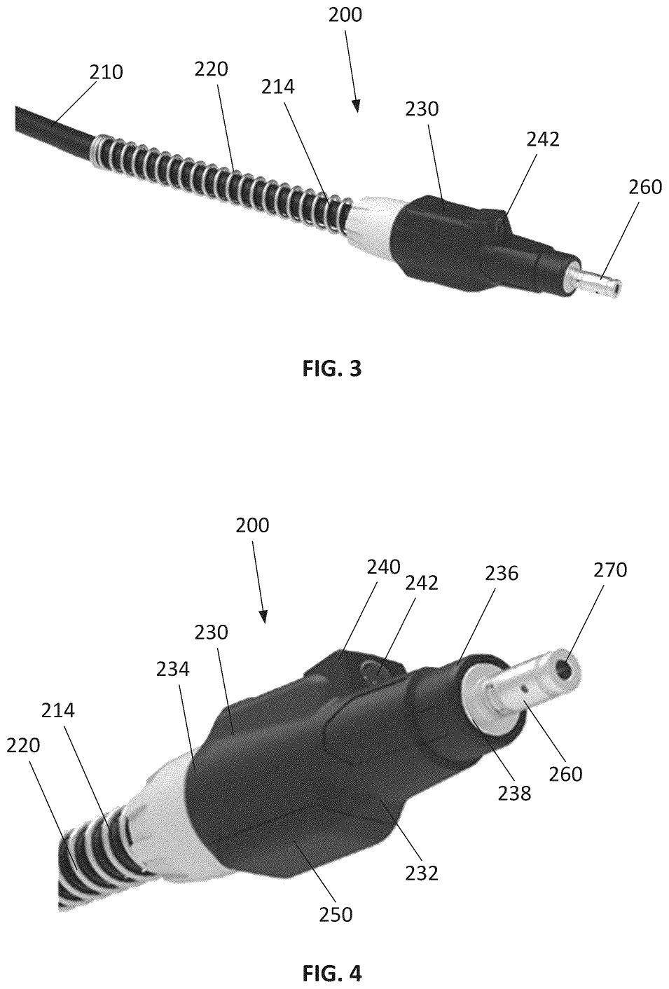

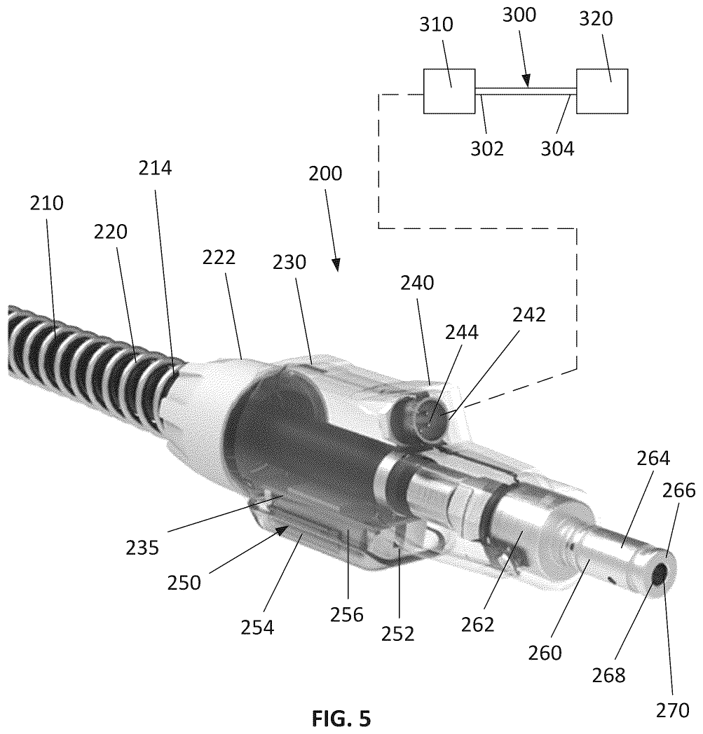

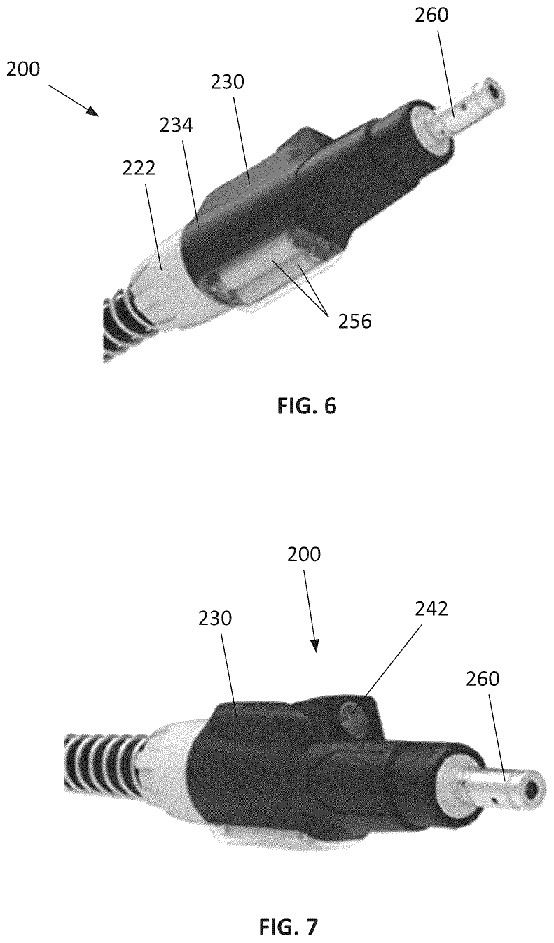

Referring to FIGS. 3-7, another embodiment of a torch and connector system according to an embodiment is illustrated. In FIGS. 5 and 6, the body of the cable support is illustrated as being transparent for case of description. The torch and connector system includes an arc process component, which may be referred to alternatively as an arc process torch cable support or connector. As shown, the arc process component or cable support/connector 200 includes a power pin 260 for receiving process power and/or fluids from a power supply, an information port 242 for receiving a machine connection plug, and a battery compartment 250 for housing one or more batteries 256, which function as an auxiliary power source.

Referring to FIGS. 4 and 5, the power pin 260 includes a fluid port 270 and conducts power and/or fluid from the power supply to a cable hose 210 of the torch cable, which in turn conducts the process power and/or fluid to the torch (not shown in this embodiment). In other words, power and/or fluid passes through the power pin 260. The cable hose 210 may also include conductors for electrically and/or operably coupling the torch components with the battery 256 and/or information port 242.

As shown in FIGS. 3 and 4, a cable support or connector 230 is coupled to an end of the cable 210. A strain relief 220 supports a portion of the cable 210 extending from the cable support 230, which is connected to the back end 214 of the cable 210. However, the illustrated position is merely exemplary and, in some embodiments, the cable support or connector 230 may be included on any portion of the cable 210. Also, in some embodiments, the cable support 230 may not include power pin, and instead may have no connections (e.g., if built into an intermediate portion of a cable) or may include torch-specific connections (e.g., if positioned adjacent to a torch).

Thus, when the cable support 230 includes an information port 242, the information port 242 has a connector 244 that has a structure and configuration that can receive a machine-specific connection cable 300 (see FIG. 5). The cable 300 may include a first end 302 having a first connector/plug 310 configured to engage the information port 242 and an opposite second end 304 having a second connector/plug 320 configured to engage a specific power supply from a particular manufacturer. Thus, the information port 242 may be coupled to a desired power supply via a corresponding machine-specific connection cable 300. An appropriate machine-specific connection cable 300 may be selected and connected to the information port 242 and the desired power supply.

Referring to FIGS. 4 and 5, the connector or cable support 230 includes a battery compartment 250 that is disposed on and/or defines a portion of the body 232 of the connector or cable support 230. The body 232 has a proximal end 234 and an opposite distal end 236 (see FIG. 4). Formed in the distal end 236 is an opening 238 through which the power pin 260 extends. Located at the proximal end 234 is a coupler 222 that engages the body 232 of the cable support 230 and that retains the strain relief 220 proximate to the cable support 230.

The battery compartment 250 is positioned at a bottom 235 of the body or housing 232, opposite the information port 242, which is located on or formed in an extending portion 240 of body 232. In this embodiment, the battery compartment 250 is generally aligned along a length of the body 232 which allows the battery compartment 250 to blend into the aesthetic of the body 232. This location and orientation of the battery compartment 250 ensures that the battery compartment 250 is easily accessible to enable a user to easily replace and/or recharge batteries (or another power source) installed therein. The illustrated position and orientation of battery compartment 250 are merely exemplary, and the battery compartment 250 could be positioned and aligned in any desired position and/or orientation.

In this embodiment, the battery compartment 250 has a cavity 252 that receives standard consumer batteries, such as two AA batteries. In other embodiments, different quantities and types of battery sources, such as AAA, 9V, etc., may be used. Also, the battery compartment 250 has a removably securable cover 254 that protects the batteries while allowing selective access thereto for removal and replacement. The cover 254 is removably secured to the body 232 of the connector or cable support 230 in any desirable manner. However, some embodiments may have a battery compartment without a removable cover. For example, in one embodiment, the auxiliary power source may be a rechargeable power source. In that embodiment, the battery compartment may include an externally accessible charging port instead of a removable cover. In yet other embodiments, the battery compartment may include a charging port and a removable cover.

Referring to FIG. 5, in this embodiment, the power pin 260 includes a base 262 that is located in the cable support 230. The power pin 260 includes an extending portion 264 that extends from the base 262 and that is located externally of the body 232 of the cable support 230. The extending portion 264 has an end 266 with a wall 268 that defines the opening or fluid port 270.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method. Moreover, the embodiments described herein may be realized in the form of a connector for a torch cable, a torch cable including the cable support/connector, a welding system, a cutting system, a torch assembly, etc.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of,” “one or more of,” “and/or,” variations thereof, or the like are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first,” “second,” “third,” etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

What is claimed is:

1. A torch cable connector assembly for use with a torch having an auxiliary component, the torch cable connector assembly comprising:
a torch cable having a first end and a second end opposite to the first end, the first end being configured to be coupled to the torch; and
a connector coupled to the second end of the torch cable, the connector including an auxiliary power source, the auxiliary power source being connectable to the auxiliary component in the torch to provide power thereto, the auxiliary power source being separate from any power being supplied to the torch for its operation.

2. The torch cable connector assembly of claim 1, wherein the connector has a first connector end and a second connector end opposite to the first connector end, the first connector end being coupled to the second end of the torch cable, and the connector has a power pin extending from the second connector end.

3. The torch cable connector assembly of claim 2, wherein power passing through the power pin does not power the auxiliary component.

4. The torch cable connector assembly of claim 1, wherein the connector has a body that defines a cavity in which the auxiliary power source is placed.

5. The torch cable connector assembly of claim 4, wherein the cavity is a battery compartment, and the auxiliary power source is a plurality of batteries located in the cavity.

6. The torch cable connector assembly of claim 1, wherein the connector includes an information port for receiving a machine connection plug.

7. A torch cable assembly, comprising:
a torch having an auxiliary component;
a torch cable having a first end and an opposite second end, the first end of the torch cable being coupled to the torch, the torch receiving power from a power supply via the torch cable; and
a cable support being coupled to the second end of the torch cable, the cable support including:
a power pin through which at least one of power or fluid passes; and
an auxiliary power source that is connected to the auxiliary component in the torch to provide power to the auxiliary component.

8. The torch cable assembly of claim 7, wherein the auxiliary component is one of an LED, a controller, a sensor, or a human-to-machine interface.

9. The torch cable assembly of claim 7, wherein the auxiliary component is a first auxiliary component, and the torch cable assembly further comprises:
a second auxiliary component located in the torch, the second auxiliary component being a different type of component than the first auxiliary component.

10. The torch cable assembly of claim 9, wherein each of the first auxiliary component and the second auxiliary component is powered by the auxiliary power source located in the cable support.

11. The torch cable assembly of claim 7, wherein the auxiliary power source includes at least one battery located in the cable support.

12. The torch cable assembly of claim 11, wherein the at least one battery is located in a cavity formed in the cable support, and the at least one battery is removable from the cavity.

13. The torch cable assembly of claim 7, wherein the cable support includes an on/off switch for connecting and disconnecting the auxiliary power source from the auxiliary component.

14. The torch cable assembly of claim 7, wherein the cable support includes an information port for receiving a machine connection plug.

15. A torch, comprising:
a handle;
an auxiliary component coupled to the handle;
a torch cable coupled to the handle; and
a cable support coupled to the torch cable, the cable support including an auxiliary power source, the auxiliary power source being connected to the auxiliary component in the handle, wherein the torch cable provides power from a power supply for operation of the torch, and the torch cable provides power from the auxiliary power source to the auxiliary component for operation of the auxiliary component.

16. The torch of claim 15, wherein the cable support is coupleable to a power supply to receive at least one of power or fluid for the torch.

17. The torch of claim 16, wherein the cable support includes a power pin extending therefrom which can receive the at least one of power or fluid for the torch.

18. The torch of claim 15, wherein the auxiliary power source includes at least one battery located in a battery compartment formed in the cable support.

19. The torch of claim 15, wherein the auxiliary component is one of an LED, a controller, a sensor, or a human-to-machine interface, and the handle includes a trigger coupled thereto, the trigger being manipulated by a user to start or stop a welding process.

20. The torch of claim 15, wherein the cable support includes an information port for receiving a machine connection plug.
